(19) United States
(12) Patent Application Publication
(10) Pub. No.: US 2020/0000134 A1
(43) Pub. Date: Jan. 2, 2020

(54) METHOD OF MAKING A PUFFED, DEHYDRATED FOOD PRODUCT

(71) Applicant: ENWAVE CORPORATION, Delta (CA)

(72) Inventors: Timothy D. DURANCE, Vancouver (CA); Guopeng ZHANG, Surrey (CA); Natalia E. SAENZ GARZA, Vancouver (CA); Reihaneh NOORBAKHSH, Vancouver (CA)

(21) Appl. No.: 16/482,558

(22) PCT Filed: Feb. 23, 2017
(86) PCT No.: PCT/CA2017/050231

§ 371 Date: Jul. 31, 2019

(51) Int. Cl. A23L 29/212; A21D 2/18; A23C 23/00; A23F 5/36; A23L 19/00; A23P 30/38

(52) U.S. Cl. CPC A23L 29/212; A21D 2/186; A23C 23/00; A23V 2002/00; A23L 19/09; A23P 30/38; A23F 5/36

(57) ABSTRACT

A method of making a puffed, dehydrated food product comprises mixing a high amylopectin starch and selected food ingredients to form a dough; forming the dough into pieces; and exposing the dough pieces to microwave radiation at a pressure less than atmospheric to puff and dry the dough pieces, producing the puffed, dehydrated food product. The ingredients may include tomato paste, yogurt, fruit or fruit juice concentrate, fruit puree, vegetable puree, vegetable puree concentrate, coffee, and concentrated soup. The dough may be formed in the absence of starch hydrolysates. The method produces dehydrated food products which incorporate a variety of food ingredients in a matrix that has a puffed, crispy structure.

### FIELD OF THE INVENTION

This invention pertains to methods of making puffed, dehydrated food products, using doughs that puff and become dry, porous structures during microwave vacuum-drying.

### BACKGROUND

It is known in the food processing art to make dehydrated food products by means of microwave vacuum-dehydration. Examples are WO 2014/085897 (Durance et al.), which discloses the production of dehydrated cheese pieces, and U.S. Pat. No. 6,313,745 (Durance et al.), which discloses the production of dehydrated and puffed berries. However, it would be desirable to produce dehydrated food products which incorporate a variety of nutritive or tasty food ingredients, in a matrix that has a puffed, crispy structure. The present invention is accordingly directed to improvements in the processes and product formulations for puffed, dehydrated food products.

### SUMMARY OF THE INVENTION

The present invention provides a method for making food products by creating elastic or flexible matrices that have the capacity for expanding under vacuum microwave-drying conditions. A high amylopectin starch is combined with other food ingredients to create a dough. The dough is formed into pieces of suitable size or frozen and cut into thin chips and then exposed to radiant energy under vacuum to eliminate water and fix the expanded structure. If native starch is used rather than a pre-gelatinized one, a cook step is required to gelatinize the starch prior to exposing the dough to radiant energy.

The method allows for drying of heat-sensitive or heat-labile biological ingredients, such as lactic acid cultures in yogurt or vitamin C in fruit. Vacuum lowers the boiling point of water and creates a pressure gradient that allows for steam to expand the matrix into an open, less dense structure that does not collapse and that maintains its increased volume. Microwaves penetrate the product, allowing for the expansion to be augmented by the steam generated within the product's core. Moisture is removed through evaporation until an expanded, rigid, shelf-stable, crispy/crunchy snack remains.

The method further allows production of crisp or crunchy formulated snacks that have a very high content of moist fruit or vegetable ingredients, a trait that is desirable for consumers who wish to include more fruits and vegetables in their diets.

According to one aspect of the invention, there is provided a method of making a puffed, dehydrated food product, comprising: (a) mixing ingredients comprising a high amylopectin starch and a selected food ingredient to form a dough; and (b) exposing the dough to microwave radiation at a pressure less than atmospheric to puff and dry the dough, producing the puffed, dehydrated food product. Preferably, the dough is made without addition of any starch hydrolysates,

According to a further aspect of the invention, there is provided a puffed, dehydrated food product formed from a dough, comprising a high amylopectin starch and a selected food ingredient, and optionally a fat. Preferably, starch hydrolysates are not present in the product.

Further aspects of the invention and features of specific embodiments of the invention are described below.

### DETAILED DESCRIPTION

The first step of the method is the mixing together of the food ingredients to form a dough. The ingredients comprise a specified form of starch, as explained below, and one or more other food ingredients. The formed doughs are elastic or stringy. Elasticity is the property of a substance that enables it to change shape, dimension or volume in direct response to a force effecting such a change, and the tendency to recover its original form upon the removal of the force. An elastic dough is one that is stretchy and has the property of trapping gas bubbles within it during expansion and drying in the microwave-vacuum apparatus, thus forming an expanded, or “puffed” structure. When the elastic dough becomes sufficiently dry, it becomes rigid and thus maintains its increased volume. This property of elasticity is imparted to the dough by the appropriate starch ingredient of the mixture. In some embodiments, the dough is stringy rather than elastic, for example when the starch is waxy corn starch, as in Example 6 below.

Starches are a family of polysaccharides used as an energy reservoir by plants including cereals, potatoes, tapioca and other important human food sources. Starches are composed primarily of straight-chain polysaccharide molecules called amyloses and branched-chain molecules called amylopectins. The starches required in the invention comprise at least 80 wt. % amylopectin. Such starches are referred to herein as “high amylopectin” starches. An example is tapioca starch, which comprises 83 wt. % amylopectin. Starches comprising less than 80% amylopectin are not useful in the invention. Suitable starches are high amylopectin starches that are pre-gelatinized, or that are native high amylopectin starches and become gelatinized during the process after mixing with the other ingredients to form the dough. Examples of suitable high amylopectin starches include pre-gelatinized waxy rice starch, pre-gelatinized waxy corn starch, and pre-gelatinized waxy tapioca starch.

Starches containing predominantly amylopectin are commonly referred to in the literature as “waxy” starches, though the term is not used consistently to denote a particular proportion of amylopectin. In this specification, the term “waxy” is limited to high amylopectin starch, i.e. one comprising at least 80 wt. % amylopectin.

Native high amylopectin starches can be used instead of pre-gelatinized starches provided that the dough is cooked in order to gelatinize the starch, prior to microwave-vacuum drying of the dough. The cooking comprises a heating step in moist conditions. Examples of suitable native starches include waxy rice starch, waxy corn starch and waxy tapioca starch.

The starch may be supplied to a formulation in the form of a flour, rather than as an isolated starch, such as rice flour (as in Example 5 below) or tapioca flour.

The presence of starch hydrolysates is avoided in the dough compositions. Starch hydrolysates comprise principally glucose with various short chain glucose polymers. When dry, they produce an undesirable glassy structure in the food product. At higher final moisture levels, starch hydrolysates give an undesirable sticky surface to the final product. This limits the handling of the product and causes sticking between pieces.

Starch hydrolysates such as glucose may lead to a collapsed and chewy texture (similar to fruit leather or fruit gummies). Prior art formulations using commercial juice concentrates (which are very high in glucose/fructose) were found to not puff sufficiently, despite the presence of the adequate amount of waxy starch. Further, the sugar concentration of such formulations is so high, that even freezing at minus 20 degrees C. was not possible, and the product remained flexible at that temperature.

Finally, high concentration of starch hydrolysates leads to high product temperature during vacuum microwave drying. One reason is that it raises the boiling point of water in the dough according to the well known Clausius-Clapeyron equation and Raoul's law. Another reason is that starch hydrolysates provide a high concentration of small molecular weight polar molecules, which in turn increase the dielectric loss factor of the dough. Increased loss factor increases the heating rate and ultimate temperature of these materials in a microwave field. High temperature can cause unwanted destruction of nutrients, vitamins, antioxidants, and beneficial live cultures such as yogurt cultures. High concentrations of simple sugars like starch hydrolysates can thus lead to localized burning. Accordingly the mixtures are formed without addition of any starch hydrolysates.

Fat is an optional ingredient in the dough. The fat may be an oil, such as olive oil, sunflower oil, canola oil and coconut oil. Other suitable fats include butter and the butter fat in whipping cream. Suitable weight ranges are from 0 wt. % to 12 wt. %, on a wet basis, preferably more than 5 wt. %. The fat aids in lubrication and the amount used is sample dependent.

The dough mixture includes another food ingredient, which imparts the dominant flavor and characteristics of the final product. Suitable food ingredients include tomato paste, yogurt, fruit or fruit juice concentrate, fruit puree, vegetable puree, vegetable puree concentrate, coffee, and concentrated soup. The selected food ingredient may comprise more than 50 wt. %, alternatively more than 60 wt. %, or alternatively more than 80 wt. % of the dough.

Other ingredients of the dough mixture may also be added, to impart particular flavors, nutritional properties and product characteristics. Examples include sugar, whey protein isolate, protein of vegetable or animal sources, yogurt bacteria, probiotic bacteria, vitamins, antioxidants, and spices.

The dough produced by mixing the ingredients is a water-based composition. In some formulations of the dough, sufficient water is present in the food ingredients themselves, e.g., in the fruit or vegetable puree, yogurt, etc. Where such ingredients do not provide sufficient water, it is added as a separate ingredient.

The ingredients are mixed thoroughly together, for example using a food blender, resulting in a dough that can be stretched, shaped, and cut into pieces. The dough is divided into bite-sized pieces in accordance with the intended form of the dried, puffed end product. For example, the dough may be extruded into balls or drops; or it may be rolled into sheets which are then cut into squares or slices; or it may be stretched and kneaded into cylinders which are sliced into chips after being half-frozen to be soft enough to cut but frozen enough to retain sliced shapes.

In some embodiments of the method, the dough pieces are frozen prior to microwave-vacuum treatment, and it is the frozen pieces that are subjected to the treatment. In other embodiments, the dough is not frozen. Freezing results in the formation of crystals of almost pure ice within the frozen dough. When the crystals melt or evaporate they leave a preformed pore within the material, which can act as a nucleus for formation of a steam bubble as water heats and evaporates under the influence of microwave heating. Thus freezing can result in more puffed or expanded structure in the final dry product than would occur without freezing. In some embodiments, the method of shaping the dough pieces requires the dough to be frozen, such as cutting semi-frozen dough.

Optionally, the dough may be subjected to preliminary drying to reduce its moisture content prior to microwave-vacuum drying. For example, in formulations in which the water content of the dough is high, it can be reduced to a lower level, e.g. in the range of 11 to 20 wt. %, by air drying before microwave-vacuum treatment.

The dough or dough pieces are then, following the optional steps of freezing or air drying, when employed, subjected to drying and puffing by means of microwave radiation and reduced pressure in a microwave vacuum-dehydrator. Methods and apparatus for microwave vacuum-drying of food products are well-known in the art.

An example of a microwave vacuum-dehydrator that is suitable for drying of the food pieces in the present invention is shown in WO 2009/049409 (Durance et al.), and is marketed by EnWave Corporation of Vancouver, Canada, under the trademark nutraREV. Using this type of apparatus, the dough pieces are placed for drying in a cylindrical basket that is transparent to microwave radiation and that has openings to permit the escape of moisture. The loaded basket is placed in the vacuum chamber with its longitudinal axis oriented generally horizontally. The pressure in the chamber is reduced. Absolute pressures in the range of about 0.1 to 100 mm of mercury, alternatively 1 to 100, alternatively 10 to 100, alternatively 3 to 30 mm of mercury, may be used. The microwave generator is actuated to radiate microwaves in the vacuum chamber. The basket is rotated within the vacuum chamber, about a generally horizontal axis, so as to slowly and gently tumble the dough pieces. The rotation of the basket may be effected, for example, by means of rollers on which the basket is supported, or by means of a rotatable cage in which the basket is placed, or by other means.

Another example of a microwave vacuum-dehydrator suitable for carrying out the step of drying is shown in WO 2011/085467 (Durance et al.), and is marketed by EnWave Corporation under the trademark quantaREV. Using this type of apparatus, the dough pieces are fed into a vacuum chamber and conveyed across a microwave-transparent window on a conveyor belt while being subjected to drying by means of low pressure and microwave radiation. Pressures in the vacuum chamber are within the ranges described above. With this type of apparatus, the dough pieces are dried while resting on the conveyor belt, and are not subjected to tumbling.

During the microwave vacuum-drying step the dough is dried and expanded as water vapor is evaporated or sublimated from it, and the expanded structure of the product is fixed. Once sufficient drying has occurred, for example to a moisture level less than 8 wt. %, the radiation is stopped, the pressure in the vacuum chamber is equalized with the atmosphere, and the dried, puffed food product is removed from the microwave vacuum-dehydrator. It will be understood that “drying” means that the moisture level is reduced to a desired level, not necessarily to zero.

The step of microwave vacuum-drying may be conducted in two stages having different conditions in order to optimize the drying conditions and quality of the product. For example, in the first stage, the microwave power level may be higher than in the second stage, or the converse; or the pressure, drying time or speed of rotation of the basket (where a rotating basket is employed) may be different. Likewise, more than two drying stages may be employed.

### EXAMPLES

### Example 1: Tomato Paste Puffs

Tomato paste 18% solids (72% w/w), pure olive oil (8% w/w), and pre-gelatinized waxy rice starch (20% w/w) were blended together using a food processor. The resulting mass was a sticky dough (initial moisture of 56% wb (wet basis)) that could be stretched and kneaded into cylinders. The cylinders were frozen and sliced when the matrix was half-frozen (soft enough to cut, but frozen enough to retain the slice shape). Slices were frozen overnight at minus 20 C. Drying was accomplished using a travelling wave laboratory scale EnWave quantaREV microwave vacuum-dryer. The fresh sample load was approximately 180 g. Absolute pressure maintained was in the range of 3.5-8 mm Hg and samples were also dried at 20 mm Hg. The microwave power was 1.2 kW for 10 minutes followed by 3.5 kW until the sample reached a final 7% moisture on wet basis and water activity of 0.33. The puffed samples retained their expanded volume and were packaged in polyethylene bags. Moisture and water activities were determined after 24 hours of storage (to allow equilibrium) using a vacuum oven and an

Aqua lab water activity meter (model series 3, Decagon Inc. Washington USA). A similar formulation was also made increasing the tomato paste to 76% w/w and decreasing the starch to 16% w/w but using pre-gelatinized tapioca starch. This matrix began at a moisture of 62% wb and was brought down to 7-8% moisture and a water activity of 0.39-0.49. Both formulations resulted in chips that were puffed, crispy, and with strong tomato flavor. Final colour was a deep red.

In a similar fashion, tomato paste 18% solids (81% w/w), pure sunflower oil (2 % w/w), and pre-gelatinized waxy rice starch (17% w/w) were blended together using a food processor. The mix (total of 300 g) was extruded into small drops/balls (approx 1 cm in diameter) and placed in an air drier at 45 C for 11 hours, until a final moisture of 17% was reached. The resulting air-dried pellets were then placed in an EnWave NutraREV drier (without the addition of any processing aids) and tumbled at 8 rpm. They were then subjected to 300 W for 120 seconds, 500 W for 300 seconds, 800 W for 200 seconds, and 300 W for 360 seconds under a chamber pressure of 20 mm Hg.

Maximum temperature observed with an IR sensor was 67 C. The resulting product had a moisture of 3-4%, a spherical/ovoid shape, bright red colour, crispy texture and strong tomato flavour.

### Example 2: Yogurt Puffs

Greek yogurt with 0% mf (73% w/w), sugar (6% w/w), butter (5% w/w), sunflower oil (4% w/w), and pre-gelatinized waxy rice starch (13% w/w) were blended together using a food processor. The resulting mass was a soft dough (initial moisture 60% wb) that could be extruded using a pastry bag. Small drops (diameter of approx. 0.5 cm) were made using the bag and were frozen overnight at minus 20 C. Drying was accomplished using a travelling wave laboratory scale EnWave quantaREV microwave vacuum-dryer. The fresh sample load was approximately 180 g. Absolute pressure maintained was in the range of 3.5-8 mm Hg and the microwave power was 1.2 kW for 10 minutes followed by 3.5 kW until the sample reached 6% moisture on wet basis and a water activity of 0.46. The puffed samples retained their expanded volume and were packaged in polyethylene bags. Drops were white in colour, very crispy and had a distinct fermented dairy flavor. Moisture and water activities were determined after 24 hours of storage (to allow equilibrium) using a vacuum oven and an Aqua lab water activity meter.

### Example 3: Coffee Puffs

Whey protein isolate 90% protein (10% w/w), sugar (5%w/w), dark roast instant coffee (4% w/w), water (21% w/w), whipping cream (22% w/w) and pre-gelatinized waxy rice starch (38% w/w) were blended together using a food processor. The resulting mass was a sticky dough (initial moisture of 38% wb) that could be stretched and kneaded into cylinders. The cylinders were frozen and sliced when the matrix was half-frozen (soft enough to cut, but frozen enough to retain the slice shape). Slices were frozen overnight at minus 20 C. Drying was accomplished using a travelling wave laboratory scale EnWave quantaREV microwave-vacuum dryer. The fresh sample load was approximately 180 g. Absolute pressure maintained was in the range of 3.5-8 mm Hg and the microwave power was 1.2 kW for 10 minutes followed by 3.5 kW until the sample reached 7% moisture on wet basis and a final Aw of 0.34. The puffed samples retained their expanded volume and were packaged in polyethylene bags. Samples were dark brown, very puffed and crispy, and had a strong coffee flavor. Moisture and water activities were determined after 24 hours of storage (to allow equilibrium) using a vacuum oven and an Aqua lab water activity meter.

### Example 4: Apple Puree Puffs

Apple puree with 36 Brix (81% w/w), coconut oil (2% w/w), and pre-gelatinized tapioca starch (17% w/w) were blended together using a food processor. The resulting mass was a sticky dough that was split into two. Half was cut into small pieces (0.5 cm by 0.5 cm) and microwave-vacuum dried. The other half was stretched and kneaded into cylinders. The cylinders were frozen and sliced when the matrix was half-frozen (soft enough to cut, but frozen enough to retain the slice shape). A small portion of dough was flattened into a sheet (0.5 cm thickness) with a rolling pin between two pieces of waxed paper. Once frozen, the wax paper was easy to remove and the sheet was cut into square-edge chips. Slices and squares were frozen overnight at minus 20 C. Drying was accomplished using a travelling wave laboratory scale EnWave quantaREV microwave vacuum-dryer. Absolute pressure maintained was in the range of 3.5-8 mm Hg and 20 mm Hg and the microwave power was 1.2 kW for 10 minutes followed by 3.5 kW until the sample reached 4% moisture on wet basis and a water activity of 0.28. The puffed samples retained their expanded volume and were packaged in polyethylene bags. Both chips and bites were crispy, had a very strong apple flavor and a slightly brown yellow colour. Moisture and water activities were determined after 24 hours of storage (to allow equilibrium) using a vacuum oven and an Aqua lab water activity meter.

This formulation was reproduced twice more using pre-gelatinized waxy rice starch and with pre-gelatinized waxy corn starch instead of tapioca with similar results but slightly softer texture in the first bite. The rice and corn formulations was reproduced with the addition of 0.2% w/w ascorbic acid. Ascorbic acid losses were negligible after microwave vacuum-drying, retaining 94-100% of the ascorbic acid that was added as was measured by 2,6-Dichlorophenolindophenol spectrophotometry.

Inoculation with Lactobacillus salivarius (7.8×10⁸ cfu/g of fresh sample) as done for the rice and corn starch formulations. Lactic acid bacteria enumeration was performed for the samples before and after microwave-vacuum drying. Counts only suffered a 0.95 log reduction in microwave vacuum-drying, proving that the method can preserve lactic acid bacteria viability.

### Example 5Tomato Puffs with Rice Flour

Hunt's (trademark) Tomato Paste: 620 g (62%), sunflower oil: 80 g (8%) and rice flour. 300 g (30%) were mixed well with a food blender. The dough was made into the shape of sausage, wrapped in food film, cooked in steam for 60 minutes, and cooled overnight at 4° C. It was rolled into thin sheets with a non-stick roller. The sheets were air dried at 75° C. for 3 hours, to a moisture content of 14.32 wt. %. The sheets were then subjected to microwave vacuum-drying in an EnWave nutraREV drier. The initial sample weight was 590 g. Absolute pressure in the vacuum chamber was maintained at 25 mm Hg and the microwave power was 1 kW for 930 seconds. The maximum temperature reached was 87° C. The final sample weight was 515 g. The final moisture content was in the range of 3-5%. The product was slightly puffed, crunchy chips with attractive colour and flavor.

### Example 6 Apple Starch Puffy Chips

SunRype (trademark) apple concentrate (36.0 Brix), 1300 g (65% w/w); Tender-Jel (trademark) pre-gelatinized waxy corn starch, 500 g (25% w/w); native tapioca starch, 100 g (5% w/w); and canola oil, 100 g (5% w/w) were mixed well with a food blender for 20 min to form homogeneous dough. The dough was divided into 50 g portions. With a tortilla presser, the dough was pressed between two sheets of parchment paper to form 2 mm thick, 14-15 cm diameter round layers. These thin dough layers were transferred onto air-drying trays, on which they were dried at 75° C. for 2 hours, or 65° C. for 3 hours, to reach a moisture content 15-20 wt. %. After air drying, the dough layers were cut into 1 cm×1 cm squares. 2% tapioca starch was added as a processing aid. The squares were subjected to microwave vacuum-drying in an EnWave nutraREV drier. The initial sample weight (having 16 wt. % moisture was 500 g. Absolute pressure in the vacuum chamber was maintained at 25 mm Hg and the microwave power was 1000 W for 600 seconds, then 750 W for 240 seconds. The speed of rotation of the drying basket was 8-10 rpm. The maximum temperature reached was 70° C. The final sample weight was 430 g. The final moisture content was in the range of 3-5%. The product was very airy, puffed chips having bright color and soft texture.

As will be apparent to those skilled in the art in the light of the foregoing disclosure, many alterations and modifications are possible in the practice of this invention without departing from the scope thereof. The scope of the invention is to be construed in accordance with the following claims.

1. A method of making a puffed, dehydrated food product, comprising:
(a) mixing ingredients comprising a high amylopectin starch and a selected food ingredient to form a dough;
(b) forming the dough into pieces; and
(c) exposing the dough pieces to microwave radiation at a pressure less than atmospheric to puff and dry the dough pieces, producing the puffed, dehydrated food product.

2. A method according to claim 1 or 2, wherein the dough is formed without addition of any starch hydrolysates.

3. A method according to claim 1 or 2, where the dough is formed in the absence of starch hydrolysates.

4. A method according to any preceding claim, wherein the high amylopectin starch is a pre-gelatinized starch.

5. A method according to any preceding claim, wherein the high amylopectin starch is selected from the group consisting of pre-gelatinized waxy rice starch, pre-gelatinized corn starch and pre-gelatinized waxy tapioca starch.

6. A method according to any one of claims 1-3, wherein the high amylopectin starch is a native starch, and the method further comprises the step of cooking the mixed ingredients to gelatinize the native starch therein before step (c).

7. A method according to claim 6, wherein the native starch is selected from the group consisting of waxy rice starch, waxy corn starch and waxy tapioca starch.

8. A method according to any one of claims 1-3, wherein the high amylopectin starch is a gelatinized starch.

9. A method according to any one of claims 1-3, wherein the high amylopectin starch comprises at least 83 wt. % amylopectin.

10. A method according to any preceding claim, wherein the high amylopectin starch is supplied in the form of a flour which comprises the high amylopectin starch.

11. A method according to any preceding claim, wherein the ingredients further comprise a fat.

12. A method according to claim 11, wherein the fat is one of olive oil, sunflower oil, canola oil, butter, whipping cream, and coconut oil.

13. A method according to claim 12, where the fat comprises more than 5 wt. % of the dough.

14. A method according to any preceding claim, wherein water is added to the ingredients in step (a).

15. A method according to any preceding claim, where the selected food ingredient is selected from the group consisting of tomato paste, fruit concentrate, fruit juice concentrate, fruit puree, vegetable puree, vegetable puree concentrate, and concentrated soup.

16. A method according to any one of claims 1-14, where the selected food ingredient comprises yogurt.

17. A method according to any one of claims 1-14, where the selected food ingredient comprises coffee.

18. A method according to any one of claims 1-14, where the selected food ingredient comprises a heat-sensitive or heat-labile composition.

19. A method according to claim 18, where the heat-sensitive or heat-labile composition comprises lactic acid culture.

20. A method according to claim 18, where the heat-sensitive or heat-labile composition comprises vitamin C.

21. A method according to any preceding claim, further comprising the step of freezing the dough prior to step (c).

22. A method according to any preceding claim, further comprising the step of reducing the moisture content of the dough prior to step (c).

23. A method according to claim 22, wherein the step of reducing the moisture content is done by air drying.

24. A method according to any preceding claim, wherein the dough produced in step (a) has an initial moisture content greater than 35 wt. %

25. A method according to any preceding claim, wherein the pressure less than atmospheric is in the range of 0.1 to 100 mm of mercury.

26. A method according to any one of claims 1-24, wherein the pressure less than atmospheric is in the range of 3 to 30 mm of mercury.

27. A method according to any preceding claim, wherein step (c) dries the dough to a moisture content less than 10 wt. %.

28. A method according to any preceding claim, wherein step (c) is done in at least two stages and a microwave power level in each stage is different.

29. A puffed, dehydrated food product made by the method of any preceding claim.

30. A puffed, dehydrated food product formed from a dough without starch hydrolysates, comprising a high amylopectin starch and a selected food ingredient.

31. A food product according to claim 30, wherein the high amylopectin starch is a pre-gelatinized starch.

32. A food product according to claim 30, wherein the high amylopectin starch is selected from the group consisting of pre-gelatinized waxy rice starch, pre-gelatinized corn starch and pre-gelatinized tapioca starch.

33. A food product according to claim 30, wherein the high amylopectin starch is a native starch.

34. A food product according to claim 33, wherein the native starch is selected from the group consisting of waxy rice starch, waxy corn starch and waxy tapioca starch.

35. A food product according to claim 30, wherein the high amylopectin starch is a gelatinized starch.

36. A food product according to any one of claims 30-35, further comprising a fat.

37. A food product according to claim 36, wherein the fat is one of olive oil, sunflower oil, canola oil, butter, whipping cream and coconut oil

38. A food product according to any one of claims 30-37, wherein the selected food ingredient is selected from the group consisting of tomato paste, fruit concentrate, fruit juice concentrate, fruit puree, vegetable puree, vegetable puree concentrate, and concentrated soup.

39. A food product according to any one of claims 30-37, wherein the selected food ingredient comprises yogurt.

40. A food product according to any one of claims 30-37, wherein the selected food ingredient comprises coffee.

41. A food product according to any one of claims 30-40, wherein the selected food ingredient comprises more than 50 wt. %, or more than 60 wt. %, or more than 80 wt. % of the elastic dough.
